(19) United States
(12) Patent Application Publication
(10) Pub. No.: US 2026/0197125 A1
(43) Pub. Date: Jul. 9, 2026

(54) DEVICES AND METHODS FOR RELIABLE COMMUNICATION IN A WIRELESS NETWORK

(71) Applicant: HUAWEI TECHNOLOGIES CO., LTD., Shenzhen (CN)

(72) Inventors: Shimon Shilo, Hod Hasharon (IL); Doron Ezri, Hod Hasharon (IL); Ezer Melzer, Hod Hasharon (IL); Oded Redlich, Hod Hasharon (IL); Yoav Levinbook, Hod Hasharon (IL); Genadiy Tsodik, Hod Hasharon (IL)

(73) Assignee: HUAWEI TECHNOLOGIES CO., LTD., Shenzhen (CN)

(21) Appl. No.: 19/559,673

(22) Filed: Mar. 6, 2026

Related U.S. Application Data
(63) Continuation of application No. PCT/EP2024/055923, filed on Mar. 6, 2024.

(30) Foreign Application Priority Data
Sep. 6, 2023 (WO) PCT/EP2023/074404

(51) Int. Cl. H04L 5/00; H04L 69/322

(52) U.S. Cl. CPC H04L 5/0007; H04L 69/322

(57) ABSTRACT

A wireless transmitter station using a resource unit (RU) or multiple resource unit (MRU) of an Orthogonal Frequency Division Multiplexing (OFDM) or Orthogonal Frequency Division Multiple Access (OFDMA) communication is disclosed. The wireless transmitter station is configured to allocate a first subset of a plurality of tones of the RU or MRU as data tones for carrying modulated data based on the bit sequence and to allocate a second subset of the plurality of tones of the RU or MRU as interference mitigation (IM) pilot tones for carrying a plurality of predefined IM pilot symbols. Moreover, the wireless transmitter station is configured to permute the plurality of tones of the RU or MRU, including both the first subset comprising

$${N}_{S D}^{IM}$$

data tones and the second subset comprising

$${N}_{SP}^{IM}$$

IM pilot tones, for obtaining a plurality of permuted tones of the RU or MRU.

### CROSS-REFERENCE TO RELATED APPLICATIONS

This application is a continuation of International Application No. PCT/EP2024/055923, filed on Mar. 6, 2024, which claims priority to International Patent Application No. PCT/EP2023/074404, filed on Sep. 6, 2023. The disclosures of the aforementioned applications are hereby incorporated by reference in their entireties.

### TECHNICAL FIELD

The present disclosure relates to wireless communications. More specifically, the present disclosure relates to devices, in particular access points (APs) and non-AP stations, and methods for reliable OFDM and OFDMA communication in a wireless communication network, in particular a Wi-Fi network.

### BACKGROUND

Reliability of data transmission in wireless communication networks is often assessed based on an upper bound of, for instance, the error rate and/or the latency of the data transmission. For instance, one of the modes of the Ultra-Reliable Low Latency Communication (URLLC) defined by the 3GPP 5G standard defines an upper bound of 0.001% for the packet error rate, while maintaining a latency of at most 1 msec. Reliability is also an important aspect of Wi-Fi networks, as defined by the IEEE 802.11 framework of standards as well as further generations thereof, such as IEEE 802.11bn (Ultra High Reliability, UHR, also referred to as Wi-Fi 8).

Uncontrolled and unexpected interference is one of the main factors preventing high reliability in wireless communication networks, in particular Wi-Fi networks. Interfering signals may occur in any bandwidth used within the Wi-Fi network. Narrowband interference, for instance, may arise from several sources, such as Wi-Fi interference, 3GPP transmissions in unlicensed bands, 2 MHz Narrowband-Assisted UWB (as part of IEEE 802.15.4ab), specifically in the 6 GHz band, and 1/2/4 MHz Bluetooth signals, in the 2.4 GHz band. Interference can arise at any time, e.g. before or during the transmission over a Wi-Fi link of a physical protocol data unit, PPDU, namely during transmission of the data-carrying part of a frame or packet. If the Wi-Fi transmitter identifies an ongoing interfering transmission in a certain frequency sub-band, it can refrain from using the corresponding sub-channel, for instance, by using preamble puncturing. This type of solution, however, cannot address unexpected interference arising during the transmission of a PPDU, which threatens the link reliability.

Within the IEEE 802.11 framework of standards enhancing reliability of packet transfer has usually been addressed by reducing the modulation and/or coding rate defined by the modulation and coding scheme, MCS. For very strong interference the lowest MCS may have to be used, which in IEEE 802.11be is binary phase-shift keying, BPSK, rate ½ combined with dual-carrier modulation, DCM; in some conditions (e.g. in the 6 GHz band), BPSK rate ½ with DCM can be employed together with a DUP scheme specified in the IEEE 802.11be Draft 4.0 standard, which may mitigate wideband interference arising during the transmission of a PPDU even though it was originally designed for coping with the different issue of reduction in the transmission power spectral density, PSD, mandated in certain frequency bands. This, however, is quite limited in the case of relatively strong interference. Furthermore, the DUP scheme is defined only for channel bandwidths of at least 80 MHz (which means duplicating a minimum of 20 MHz chunks of the transmitted signal, for increasing the link reliability) and only for transmission to a single receiver. With the DUP scheme, data using BPSK rate ½ with DCM (where the use of DCM effectively reduces the code rate to ¼) is duplicated in the frequency domain using twice the bandwidth (with an additional partial sign change in order to reduce the PAPR), which is therefore roughly equivalent to using an extremely low MCS of BPSK with code rate of ⅛.

In addition, in IEEE 802.11be DCM is used only with BPSK rate ½, which effectively means DCM is an additional, lower (more robust) modulation, and cannot be used with a high-rate, high MCS. Thus, the conventional reliability enhancement mechanisms are deficient in the sense that they mandate reducing the modulation to BPSK (the lowest possible modulation) with coding rate ½, and therefore increase the packet duration considerably. For applications that require reliability, where low error rate is required while maintaining some upper-bound on the latency, this type of approach is not suitable.

### SUMMARY

The present disclosure provides improved devices, in particular access points and non-AP stations, and methods for reliable OFDM and OFDMA communication in a wireless network, in particular a Wi-Fi network.

According to a first aspect a wireless transmitter station is provided for transmitting a bit sequence to a wireless receiver station over a wireless channel using a resource unit, RU, or multiple resource unit, MRU, of an Orthogonal Frequency Division Multiplexing, OFDM, or Orthogonal Frequency Division Multiple Access, OFDMA, communication. The wireless transmitter station according to the first aspect and the wireless receiver station may be a WLAN or Wi-Fi transmitter station and a WLAN or Wi-Fi receiver station in accordance with the IEEE 802.11 framework of standards.

The wireless transmitter station according to the first aspect is configured to allocate a first subset of a plurality of tones of the RU or MRU as data tones for carrying modulated data, in particular quadrature amplitude modulation, QAM, symbols based on the bit sequence and to allocate a second subset of the plurality of tones of the RU or MRU as interference mitigation, IM, pilot tones for carrying a plurality of predefined IM pilot symbols. Moreover, the wireless transmitter station according to the first aspect is configured to permute the plurality of tones of the RU or MRU, including both the first subset comprising

$${N}_{SD}^{IM}$$

data tones and the second subset comprising

$${N}_{SP}^{IM}$$

IM pilot tones, for obtaining a plurality of permuted tones of the RU or MRU. The wireless transmitter station according to the first aspect is further configured to map the plurality of permuted tones onto a plurality of frequency subcarriers of the RU or MRU for generating a modulated signal and to transmit the modulated signal over the wireless channel to the wireless receiver station. By including the plurality of IM pilot tones in the transmission the wireless transmitter station according to the first aspect facilitates the interference mitigation by the wireless receiver station for the data portion of the packet resulting in an improved reliability of the communication link and data transfer between the transmitter and the receiver.

In a further possible implementation form, the modulated signal comprises the data part of a physical protocol data unit, PPDU, and the data part of the PPDU comprises a sequence of OFDM or OFDMA symbols, wherein the number of data tones of the last symbol of the sequence of OFDM or OFDMA symbols is an integer multiple of a parameter N_{SD,short} and smaller than the number of data tones N_{SD} of the other, i.e. previous, symbols of the sequence of OFDM or OFDMA symbols.

In a further possible implementation form, the value of the parameter N_{SD,short} for computing the number of data tones of the last OFDM symbol is equal to the value of N_{SD,short} that corresponds to the largest RU or MRU

$${N}_{SD , short}^{standard}$$

as defined by the IEEE 802.11 framework of standards (in particular the amendments IEEE 802.11ax/be/bn) that is smaller than the number

$${N}_{SD}^{IM}$$

of data tones of the first subset.

In a further possible implementation form, the value of the parameter N_{SD,short} for computing the number of data tones of the last OFDM symbol is given by:

$${N}_{SD , short} = round [ ( {N}_{SD}^{IM} / {N}_{SD} ) \cdot {N}_{SD , short}^{standard} ] ,$$

wherein round[ ] denotes a rounding-to-the-nearest-integer operation, in particular round-up or round-down operation, and

$${N}_{SD , short}^{standard}$$

is used to determine the number of data tones of the last symbol of the sequence of OFDM or OFDMA symbols defined by the IEEE 802.11 framework of standards for the RU or MRU corresponding to the value of N_{SD} and where

$${N}_{SP}^{IM} = 0 ,$$

when the last OFDM or OFDMA symbol is not fully used by data symbols.

In a further possible implementation form, the value of the parameter N_{SD,short} for computing the number of data tones of the last OFDM symbol is given by:

$${N}_{SD , short} = round [ {N}_{S D}^{IM} / 4 ] ,$$

wherein round[ ] denotes a rounding-to-the-nearest-integer operation, in particular round-up or round-down.

In a further possible implementation form, the wireless transmitter station is further configured to transmit an indication to the wireless receiver station indicating that the RU or MRU used for transmission to the wireless receiver station includes the second subset of the plurality of tones of the RU or MRU, i.e. the plurality of IM pilot tones.

In a further possible implementation form, the indication for the wireless receiver station is further indicative of the number of tones

$${N}_{SD}^{IM}$$

of the first subset or the plurality of tones of the RU or MRU.

In a further possible implementation form, the wireless transmitter station is configured to transmit the modulated signal over the wireless channel to the wireless receiver station in the form of a physical protocol data unit, PPDU, wherein the indication comprises one or more bits of one or more PHY header fields of the PPDU and wherein the one or more PHY header fields comprise a Universal SIG, U-SIG, field, and/or an Ultra High Reliability SIG, UHR-SIG, field.

In a further possible implementation form, the wireless transmitter station is configured to transmit a plurality of beacon frames to the wireless receiver station, wherein one or more of the plurality of beacon frames comprise the indication.

In a further possible implementation form, the wireless transmitter station comprises a segment parser configured to divide the RU or MRU into a plurality of segments such that each segment of the plurality of segments comprises one or more tones of the second subset

$${N}_{SP}^{IM}$$

of the plurality N_{SD} of tones of the RU or MRU, i.e. IM pilot tones.

In a further possible implementation form, the segment parser is configured to divide the RU or MRU into the plurality of segments such that for each segment of the plurality of segments the ratio between the number of tones of the first subset and the second subset is approximately equal.

In a further possible implementation form, the first subset of the plurality of tones of the RU or MRU comprises a number of tones

$${N}_{SD}^{ID}$$

corresponding to the tones

$${N}_{SD}^{′}$$

of a RU or MRU defined by the IEEE 802.11 framework of standards, where

$${N}_{SD}^{′} < {N}_{SD} .$$

In a further possible implementation form, the wireless transmitter station is configured to first allocate the first subset of the plurality of tones of the RU or MRU and then allocate the remaining tones of the RU or MRU not being part of the first subset as the second subset of the plurality of tones of the RU or MRU.

In a further possible implementation form, the wireless transmitter station is configured to first allocate the second subset of the plurality of tones of the RU or MRU and then allocate the remaining tones of the RU or MRU not being part of the second subset as the first subset of the plurality of tones of the RU or MRU.

In a further possible implementation form, the wireless transmitter station is configured to allocate the second subset in a plurality of subgroups of tones spread over one or more frequency ranges defined by the plurality of tones of the RU or MRU, wherein each subgroup of tones comprises a plurality of contiguous tones.

In a further possible implementation form, the RU or MRU defined by the IEEE 802.11 framework of standards comprises 26, 52, 52+26, 106, 106+26, 242, 484, 484+242, 996, 996+484, 996+484+242, 2*996, 2*996+484, 3*996, 3*996+484 or 4*996 tones.

In a further possible implementation form, the RU or MRU further comprises a plurality of carrier frequency offset, CFO, pilot tones.

In a further possible implementation form, the wireless transmitter station is configured to perform the permutation operation using a LDPC tone-mapper as specified by the IEEE 802.11 framework of standards.

In a further possible implementation form, the wireless transmitter station is configured to generate the IM pilot tone symbols for one or more of the plurality of IM pilot tones by combining or concatenating one or more generator binary phase shift keying, BPSK, symbol sequences one or more times and multiplying each generator BPSK symbol sequence by a factor of 1 or −1. As used herein, a BPSK symbol sequence of a certain length is a sequence of complex values, each one taking one of two possible nonzero values differing by a sign, obtained from a bit sequence of the same length via mapping each bit onto its respective point in a BPSK constellation map.

In a further possible implementation form, the one or more generator BPSK symbol sequences comprises one or more of the following sequences: [−1 1 −1 −1 −1 −1]; [1 −1 −1 −1 1−1]; [1 1 1 −1 −1 −1]; and [−1 1 −1 −1 −1 −1 1 −1 −1 −1 1 −1 1 1 1 −1 −1 −1].

In a further possible implementation form, for combining or concatenating the one or more generator BPSK symbol sequences the wireless transmitter station is configured to insert up to 5 additional BPSK symbols between the one or more generator BPSK symbol sequences.

In a further possible implementation form, the wireless transmitter station is configured to transmit a null signal over one or more of the plurality of IM pilot tones. In other words, in an implementation form, the wireless transmitter station is further configured to transmit a null signal on one or more tones of the second subset of the plurality of data tones of the RU or MRU.

In a further possible implementation form, the wireless transmitter station is further configured to transmit an indication to the wireless receiver station indicative that the RU or MRU used for transmission to the wireless receiver station includes the second subset of the plurality of data tones of the RU or MRU. As already described above, in an implementation form, the second subset of the plurality of data tones of the RU or MRU carries the predefined IM pilot symbols.

In a further possible implementation form, the indication to the wireless receiver station is further indicative of the location of the second subset of the plurality of data tones of the RU or MRU within the RU or MRU.

In a further implementation form, the wireless transmitter station is configured to transmit the bandlimited modulated signal over the wireless channel to the wireless receiver station in the form of a physical protocol data unit, PPDU.

In a further possible implementation form, the indication comprises one or more bits of one or more PHY header fields of the PPDU or of a Trigger Frame and wherein the one or more PHY header fields comprise a Universal SIG, U-SIG, field, and/or an Ultra High Reliability SIG, UHR-SIG, field.

According to a second aspect a method is provided for transmitting a bit sequence to a wireless receiver station over a wireless channel using a resource unit, RU, or multiple resource unit, MRU, of an Orthogonal Frequency Division Multiplexing, OFDM, or Orthogonal Frequency Division Multiple Access, OFDMA, communication. The method according to the second aspect comprises the following steps:
allocating a first subset of a plurality of tones of the RU or MRU as data tones for carrying modulated data based on the bit sequence;
allocating a second subset of the plurality of tones of the RU or MRU as interference mitigation, IM, pilot tones for carrying a plurality of predefined IM pilot symbols;
permuting the plurality of tones of the RU or MRU, including both the first subset comprising

$${N}_{SD}^{IM}$$

data tones and the second subset comprising

$${N}_{SP}^{IM}$$

IM pilot tones, for obtaining a plurality of permuted tones of the RU or MRU;
mapping the plurality of permuted tones onto a plurality of frequency subcarriers of the RU or MRU for generating a modulated signal; and
transmitting the modulated signal over the wireless channel to the wireless receiver station.

The method according to the second aspect can be performed by the wireless transmitter station according to the first aspect. Thus, further features of the method according to the second aspect result directly from the functionality of the wireless transmitter station according to the first aspect as well as its different implementation forms described above and below.

According to a third aspect a computer program product is provided, comprising program code which causes a computer or a processor to perform the method according to the second aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a wireless communication network, in particular a Wi-Fi network including a wireless transmitter station according to an embodiment in communication with a plurality of wireless receiver stations;

FIG. 2 shows a schematic diagram illustrating modules of a wireless transmitter station according to an embodiment for transmitting a bit sequence;

FIGS. 3a, 3b and 3c show schematic diagrams illustrating exemplary transmission processing chains implemented by a wireless transmitter station;

FIGS. 4a and 4b show diagrams illustrating the allocation of data tones and interference mitigation pilot tones in a resource unit used by a wireless transmitter station according to different embodiments;

FIG. 5 shows a table illustrating for a plurality of resource unit sizes and the number of data tones in the resource unit used by a wireless transmitter station according to an embodiment;

FIG. 6 shows a flow diagram illustrating steps of a method according to an embodiment for transmitting a bit sequence to a wireless receiver station; and

FIG. 7 shows plotted curves illustrating the performance of data transfer between a wireless transmitter station operating according to different embodiments and a wireless receiver station.

In the following, identical reference signs refer to identical or at least functionally equivalent features.

### DETAILED DESCRIPTION OF THE EMBODIMENTS

In the following description, reference is made to the accompanying figures, which form part of the disclosure, which illustrate specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

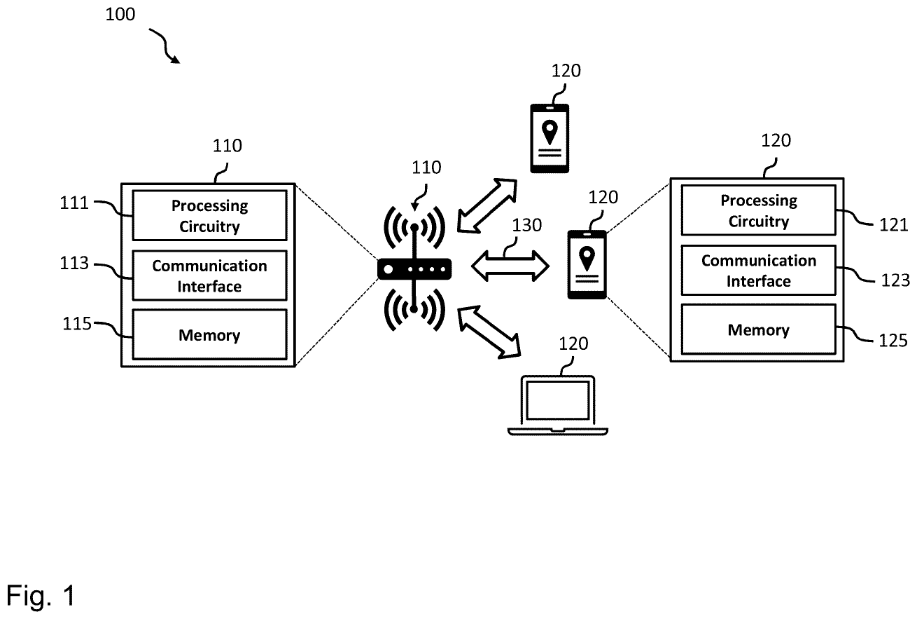

FIG. 1 shows a wireless communication network 100, in particular a wireless communication network in accordance with the IEEE 802.11 framework of standards (also referred to as a Wi-Fi network 100). The Wi-Fi network 100 comprises a wireless transmitter station 110 (also referred to as Wi-Fi station 110 herein), which may be implemented in the form of a multi-antenna AP 110, and a plurality of wireless receiver stations 120 (also referred to as further Wi-Fi stations 120 herein) in the form of, for instance, non-AP stations 120. As illustrated in FIG. 1, by way of example, the non-AP stations 120 may comprise smartphones, laptop computers, tablet computers, desktop computers or other types of wireless devices 120. In the following several embodiments of the AP 110 as wireless transmitter station 110 will be described in more detail below. As will be appreciated, however, the non-AP stations 120 may be implemented as a wireless transmitter station as well in accordance with the following embodiments.

As further illustrated in FIG. 1, the AP 110 comprises a processing circuitry 111 and a communication interface 113, in particular a wireless communication interface 113 enabling communication in accordance with the IEEE 802.11 framework of standards over a channel 130. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

Likewise, as indicated in FIG. 1, the non-AP station(s) 120 comprise a processing circuitry 121 and a communication interface 123, in particular a wireless communication interface 123 enabling a communication in accordance with the IEEE 802.11 framework of standards over the channel 130. The processing circuitry 121 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The non-AP station(s) 120 may further comprise a memory 125 configured to store executable program code which, when executed by the processing circuitry 121, causes the non-AP station(s) 120 to perform the functions and methods described herein.

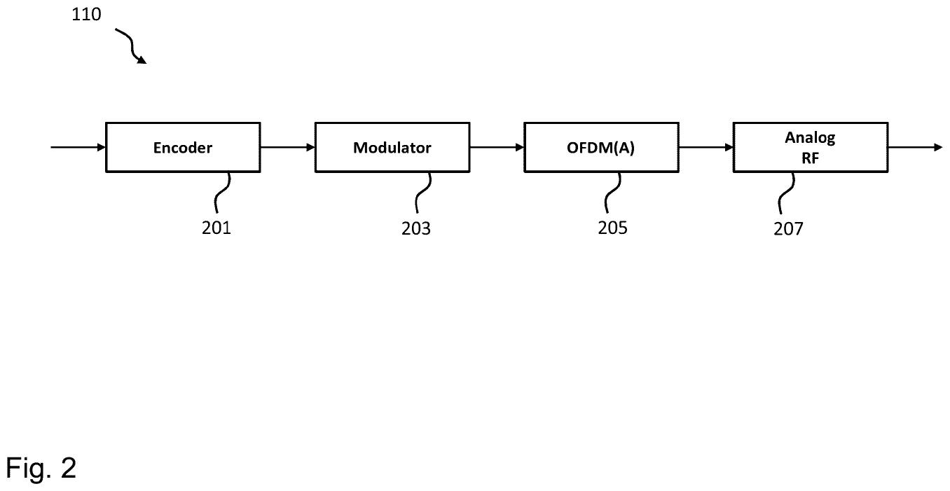

As illustrated in FIG. 2, in an embodiment, the processing circuitry 111 of the AP 110 may implement an encoder 201, for instance, an LDPC encoder 201 configured to encode a message, i.e. a bit sequence into a codeword with a predefined coding rate. In an embodiment, the encoder 201 is configured to generate the codeword using one or more of the plurality of LDPC codes defined by the IEEE 802.11 framework of standards, for instance, IEEE 802.11n, IEEE 802.11ac, or any future evolution of the IEEE 802.11 framework of standards.

As further illustrated in FIG. 2, in an embodiment, the AP 110 may further comprise a modulator 203 configured to modulate the codewords generated by the encoder 201 based on, for instance, a QAM scheme into a plurality of modulation symbols, for instance, QAM symbols. In an embodiment, the modulator 203 is configured to modulate the codewords generated by the encoder 201 based on a BPSK, QPSK, 16-QAM, 64-QAM, 256-QAM, 1024-QAM and/or 4096-QAM scheme into the plurality of modulation symbols, i.e. the symbol stream. In an embodiment, the modulator 203 is configured to modulate the codewords generated by the encoder 201 based on the modulation schemes defined by the IEEE 802.11 framework of standards.

In the embodiment shown in FIG. 2, the transmission processing chain of the AP 110 implemented by the processing circuitry 111 and/or the communication interface 113 of the AP 110 may further comprise an OFDM/OFDMA module 205 and an analog RF module 207. For instance, in case of IEEE 802.11ac the symbol stream may be transmitted by an OFDM and/or OFDMA technique which may involve additional steps implemented by the OFDM/OFDMA module 205, such as a serial to parallel conversion before calculating an Inverse Fast Fourier Transform (IFFT). The analog RF module 207 may be configured to generate, based on the output from the OFDM/OFDMA module 205, the actual antenna feed signals for generating the RF transmission to the plurality of non-AP stations 120.

Before describing different embodiments of the wireless transmitter station 110, e.g. the AP 110 in more detail, in the following some technical background as well as terminology will be introduced making use of one or more of the following abbreviations:
AP Access Point
BCC Binary Convolutional Code
BPSK Binary Phase-Shift Keying
BW Bandwidth
CFO Carrier Frequency Offset
CSD Cyclic Shift Delay
DCM Dual-Carrier Modulation
DUP Duplicate Transmission (defined in the IEEE 802.11be standard)
FEC Forward Error Correction
IDFT/IFFT Inverse Discrete/Fast Fourier Transform
IEEE Institute of Electrical and Electronics Engineers
IM Interference Mitigation
LDPC Low Density Parity Check
LTF Long Training Field
MCS Modulation and Coding Scheme (Rate)
MIMO Multiple Input Multiple Output
MRC Maximal Ratio Combining
MRU Multi(ple)-RU
MU Multi-User
MVDR Minimum Variance Distortionless Response
N_CBPS Number of Coded Bits per OFDM Symbol
N_DBPS Number of data Info Bits per OFDM Symbol
OFDM/A Orthogonal Frequency Division Multiplexing/Multiple-Access
PAPR Peak-to-Average Power Ratio
PER Packet Error Rate
PHY PHYsical layer
PPDU PHY Protocol Data Unit
PSD Power Spectral Density
QAM Quadrature Amplitude Modulation
RU Resource Unit
RX/Rx Receiver
SIR Signal to Interference power Ratio
SNR Signal to Noise power Ratio
STA Station, may be an AP STA or a non-AP STA
STF Short Training Field
TX/Tx Transmitter
UHR Ultra High Reliability
U-SIG Universal SIG (name of a signal field in 802.11be)
UWB Ultra-Wide-Band
WLAN Wireless Local Access Network

IEEE 802.11 WLAN standards prior to 802.11ax (including 802.11a/g/n/ac) supported only an OFDM mode, where the entire BW was used to transmit data to a single STA or multiple STAs (in a multi-user MIMO mode). Starting with 802.11ax (and then 802.11be), OFDMA is supported, where non-overlapping portions of the BW (called Resource Units or RUs) can be allocated to one or more STAs. The standard defines the RUs supported for different bandwidths of the channel, for instance, 20 MHz and 40 MHz BW. In particular for the case of 20 MHz, the transmitter may choose to transmit on the entire BW using a 242-tone RU (to one or more STAs, the latter by transmitting in an MU-MIMO mode), or using OFDMA where any combination of non-overlapping RUs, smaller than 242-tones, can be used. In particular, the transmitter may choose to transmit on RUs of size 26-tones, 52-tones or 106-tones (IEEE 802.11be also supports MRUs such as the combinations of 52+26 tones and 106+26 tones). In IEEE 802.11ax and 802.11be, each receiving STA can be allocated a single RU (or MRU, in the case of IEEE 802.11be) within a PPDU which may contain data intended for multiple receiving STAs. It is important to note that whereas a 52-tone RU is exactly double the size of a 26-tone RU, a 106-tone RU is slightly larger than two 52-tone RUs (since a pair of null subcarriers, reserved as spectral guards between the 52-tone RUs, are now included as additional tones in the 106-tone RU) and a 242-tone RU is larger than two 106-tone RUs (there are 30 additional tones).

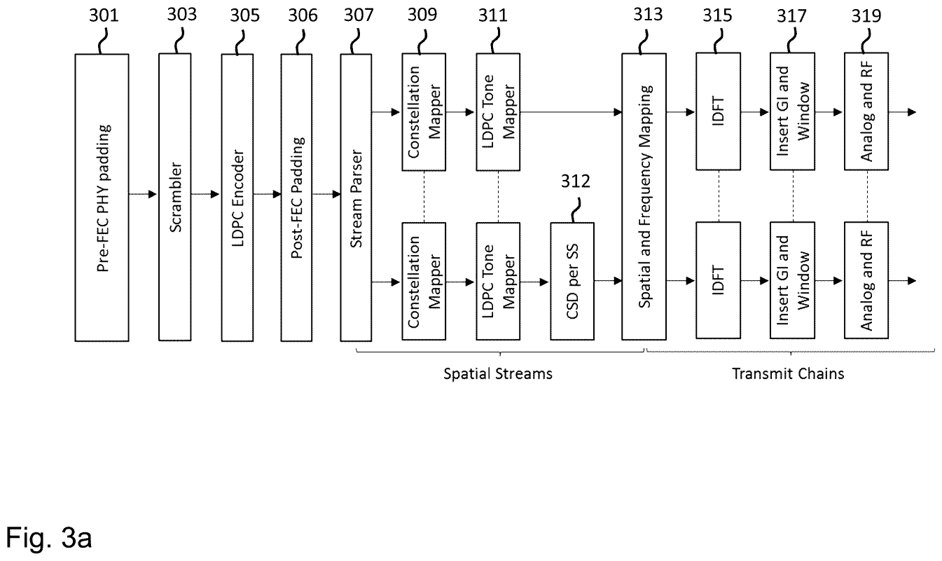

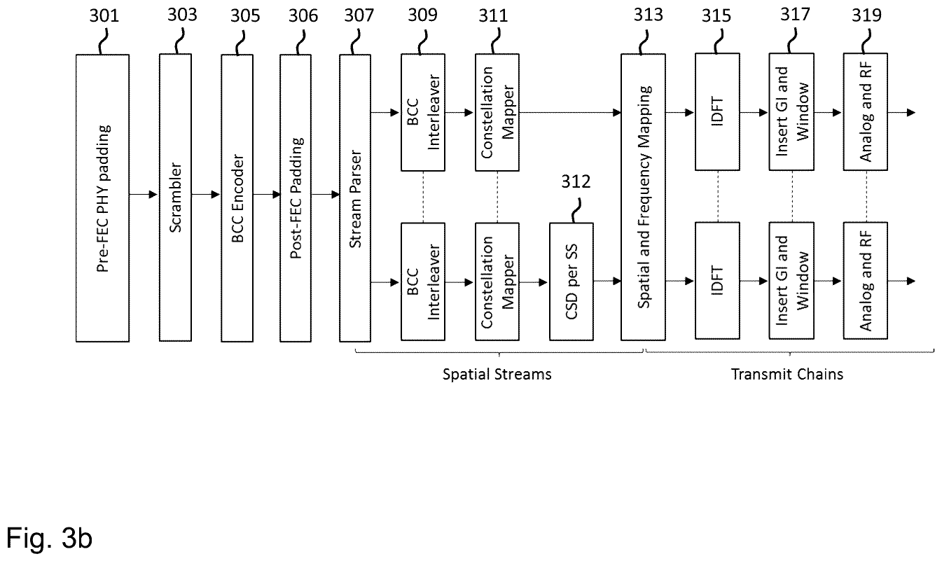

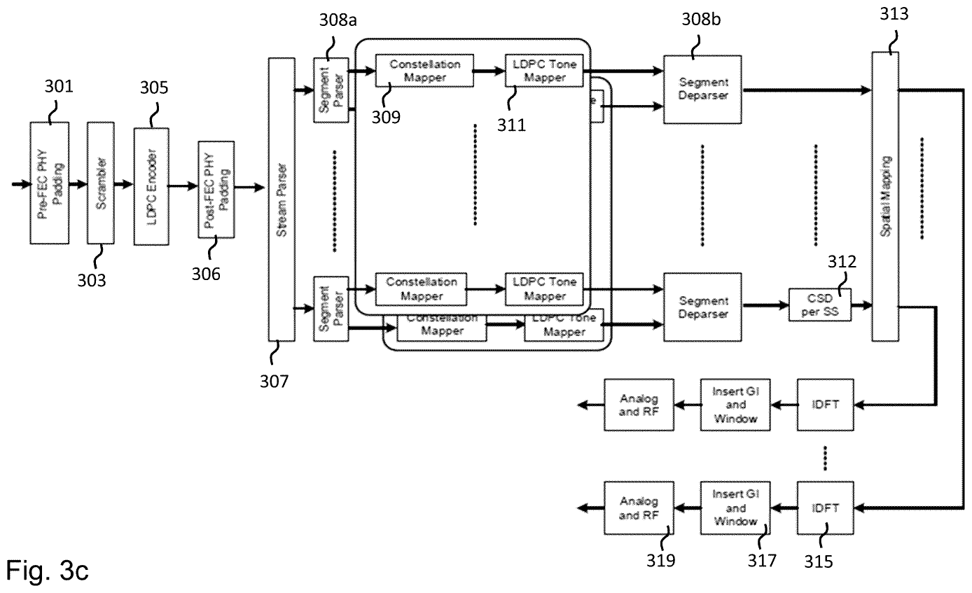

FIGS. 3a, 3b and 3c show schematic diagrams illustrating exemplary transmission processing chains in compliance with the IEEE 802.11 framework of standards. As will be described in more detail further below, the wireless transmitter station 110 according to an embodiment may comprise and/or implement one or more of the processing blocks of one of the transmission processing chains shown in FIGS. 3a, 3b and 3c.

FIG. 3a illustrates the transmission processing chain for LDPC-encoded data as defined by the IEEE 802.11 framework of standards, in particular IEEE 802.11be and 802.11ax. Bits from the MAC layer undergo pre-FEC padding in a block 301 (if applicable), scrambling in a block 303, encoding using an LDPC encoder 305, and post-FEC padding 306. If multiple spatial streams are used the post-FEC padded bits are divided by a stream parser 307 between the spatial streams before they are fed into a respective constellation mapper 309 which applies a constellation mapping procedure (e.g. using BPSK/QPSK/16-QAM and the like) onto the bit streams. The resulting modulation symbols, in particular QAM symbols are interleaved in frequency using a LDPC Tone Mapper 311, then a cyclic shift delay, CSD, may be applied per spatial stream by a block 312 followed by spatial mapping (e.g. beamforming) and then mapping to subcarriers (see block 313) before the application of the IDFT/IFFT operation by blocks 315, which creates the samples of the OFDM symbol in time domain. Finally, a guard interval may be inserted in block 317 and the analog and RF blocks 319 may generate the actual antenna feed signals, based on the output from the preceding blocks, for generating the RF transmission to the plurality of wireless receiver stations 120, e.g. the non-AP stations 120. As will be appreciated, the frequency mapping block 313 maps each STA's allocation onto the used subcarriers/tones in frequency, before the IDFT/IFFT blocks 315 which operate on an entire OFDM symbol (the latter may contain data allocated to multiple target stations). In other words, all blocks, i.e. modules prior to the frequency mapping operation are carried out per allocation, independently.

FIG. 3b illustrates the transmission processing chain for BCC-encoded data as defined by the IEEE 802.11 framework of standards, in particular IEEE 802.11be and 802.11ax. Bits from the MAC layer undergo pre-FEC padding by block 301 (if applicable), scrambling by block 303, encoding using a BCC encoder 305, and post-FEC padding 306.

If multiple spatial streams are used the post-FEC padded bits are divided by a stream parser 307 between the spatial streams. The bits then undergo interleaving by a respective BCC interleaver block 309 and mapping to points of a selected constellation (e.g. BPSK/QPSK/16-QAM and the like) by a respective constellation mapper 311. A cyclic shift delay may be applied per spatial stream by a respective block 312 followed by spatial mapping (e.g. beamforming) and then mapping to subcarriers (see block 313) before the application of the IDFT/IFFT operation by blocks 315, which creates the samples of the OFDM symbol in the time domain. Finally, a guard interval may be inserted in block 317 and the analog and RF blocks 319 may generate the actual antenna feed signals, based on the output from the preceding blocks, for generating the RF transmission to the plurality of wireless receiver stations 120, e.g. the non-AP stations 120. As will be appreciated, the frequency mapping block/module 313 maps each STA's allocation onto the used subcarriers/tones in frequency, before the IDFT/IFFT block/module 315 which operates on an entire OFDM symbol (the latter may contain multiple allocations). In other words, all blocks/modules prior to the frequency mapping operation are carried out per allocation, independently.

FIG. 3c illustrates the transmission processing chain for LDPC-encoded data as defined by the IEEE 802.11 framework of standards, in particular IEEE 802.11be and 802.11ax for the case that the RU size is larger than 996-tones. In this case the data bits (after encoding and stream parsing, which is identical to the embodiment of FIG. 3a described above) are divided by a plurality of segment parsers 308a into multiple segments that are not larger than 996-tones as illustrated in FIG. 3c. After dividing the bits between segments, they are mapped to QAMs and the LDPC tone mapping is performed per each segment independently in the same way as for the embodiment of FIG. 3a described above and then recombined by a respective segment deparser 308b. Whereas according to IEEE 802.11ax the segments are always of the same size (e.g. 2×996-tones), Multi-RUs according to IEEE 802.11be are not necessarily symmetric and the component RUs (and hence segment sizes) are not necessarily identical in size (e.g. an MRU of size 996+484). The IEEE 802.11be standard defines how to divide the bits between segments, in particular for those of different sizes.

Both standards IEEE 802.11ax and 802.11be define the operation of BCC interleaving (see blocks 309 of FIG. 3b) and LDPC tone-mapping (see blocks 311 of FIG. 3a) for every valid RU size. As used herein, the term ‘RU size’ should also be understood as referring to ‘MRU size’, when applicable, as in the case of IEEE 802.11be and possibly further generations of the IEEE 802.11 family of standards. The interleaving parameters defined for every RU size are intended to avoid a too small separation in the frequency domain between tones of the RU which carry the information encoded by contiguous bits (or QAMs) in the payload, to yield sufficient frequency diversity and improve detection performance at the wireless receiver station 120.

In order to track and compensate any residual carrier frequency offset, CFO, and phase noise, CFO pilots (represented as predefined BPSK symbols modulating specific predefined tones, both known to the wireless receiver station) are transmitted throughout the PPDU, and are inserted into almost every transmitted OFDM symbol in the frame, including OFDM symbols carrying LTF and data and OFDM symbols carrying the SIG fields: L-SIG, U-SIG, UHR-SIG. The number of CFO pilots are defined by the IEEE 802.11 framework of standards for different RUs in the following way:
26-tone RU: 2 CFO pilots (the remaining 24 tones are used for data)
52-tone RU: 4 CFO pilots (the remaining 48 tones are used for data)
106-tone RU: 4 CFO pilots (the remaining 102 tones are used for data)
242-tone RU: 8 CFO pilots (the remaining 234 tones are used for data)
484-tone RU: 16 CFO pilots (the remaining 468 tones are used for data)
   CFO pilots do not undergo LDPC tone-mapping or any form of frequency interleaving.

In the following a simple example will be described for illustrating how a wireless receiver station may conventionally try to cope with or mitigate interference. For simplicity, a single spatial stream for both the desired target signal and the interfering signal is assumed. The dimension of all the vectors involved (indicated by boldface letters) is equal to the number of receive antennas, which is assumed to be greater than 1. The signal received by a wireless receiver station may be expressed in the following form:

$$y = hs + ρ n + g r ,$$

wherein y denotes the received signal, h denotes the channel of the desired target signal s, p denotes the noise intensity (which is related to the SNR in the following way: ρ²=1/SNR), n denotes the normalized additive white Gaussian noise, AWGN, and r denotes the interfering signal that experiences the channel g. The covariance of the noise and interference terms is given by the following matrix C:

$$C = E [ ( ρ n + g r ) {( ρ n + g r )}^{*} ] = {ρ}^{2} I + {gg}^{*} ,$$

wherein E[ ] denotes the expectation value and the symbol * denotes Hermitian conjugation. If the covariance is known to the wireless receiver station, then the wireless receiver station can use the covariance to compute a Minimum Variance Distortionless Response (MVDR) beamformer (which is equivalent to whitening the spatial noise and interference prior to demodulation), to estimate the transmitted signal in the following way:

$$\hat{s} = \frac{{h}^{*} {C}^{- 1} y}{{h}^{*} {C}^{- 1} h} .$$

As will be appreciated, alternative interference mitigation schemes may be employed by a wireless receiver station for conventionally mitigating interference.

Both IEEE 802.11ax and 802.11be define partial data usage—where applicable—of the last OFDM symbol (within the PPDU). In order to allow a wireless receiver station more time to decode the packet and prepare its response, data is not necessarily padded to fill the entire last OFDM symbol. Instead, the last OFDM symbol is divided usually into four (typically unequal) ‘sections’, and padding is carried out only towards the last ‘section’ containing data.

For example, in a 242-tone RU for which the number of subcarriers, i.e. tones used for data (denoted as N_{SD}) is 234 and the remaining 242−234=8 tones are used for CFO pilots, the parameter N_{SD,short} defines the size of such a ‘section’, which in this case is defined in the standard as N_{SD,short}=60. This means that, if the number of QAMs generated by data is less than or equal to 60, then only the first ‘section’ is filled with data, and the rest of the 234-60=174 tones are filled with (post-FEC) padding which is usually ignored by the wireless receiver station. Similarly, if the number of QAMs generated by data is larger than 60 but smaller or equal to 120, then only the first two ‘sections’ are filled with data, and the rest of the 234−120=114 tones are filled with (post-FEC) padding which is ignored by the wireless receiver station. The values for the parameter N_{SD,short} are defined by the IEEE 802.11 framework of standards for each RU size.

Embodiments disclosed herein allow mitigating interference by transmitting known pilots (herein referred to as interference mitigation, IM, pilots) within an RU (or MRU), spread across the entire bandwidth of the RU or MRU allocated for data transmission, so that the wireless receiver station(s) 120 can use these IM pilots to estimate the interference and mitigate it. In the following several different embodiments for spreading the IM pilots in frequency will be described, wherein some embodiments minimize the required changes to existing designs.

Generally, the wireless transmitter station 110 (or alternatively the station 120 when acting as transmitter) is configured to allocate a first subset of a plurality of tones of an RU or MRU as

$${N}_{SD}^{IM}$$

data tones for carrying modulated data based on the bit sequence and to allocate a second subset of the plurality of tones of the RU or MRU as

$${N}_{SP}^{IM}$$

interference mitigation, IM, pilot tones for carrying a plurality of predefined IM pilot symbols. Moreover, the wireless transmitter station 110 is configured to permute the plurality of tones of the RU or MRU, including both the first subset comprising

$${N}_{SD}^{IM}$$

data tones and the second subset comprising

$${N}_{SP}^{IM}$$

IM pilot tones, for obtaining a plurality of permuted tones of the RU or MRU. The wireless transmitter station 110 is further configured to map the plurality of permuted tones onto a plurality of frequency subcarriers, i.e. tones of the RU or MRU for generating a modulated signal and transmitting the modulated signal over the wireless channel 130 to the wireless receiver station 120 (or alternatively the station 110, when the station 120 is operating as the transmitter wireless station 120).

In an embodiment, the wireless transmitter station 110 for generating the modulated signal in the way described above may comprise and/or implement one or more of the plurality of processing blocks shown in FIG. 3a, 3b or 3c. For instance, in an embodiment the wireless transmitter station 110 may comprise the LPDC tone mapper 311 for permuting the plurality of tones of the first subset and the plurality of IM pilot tones of the second subset. In an embodiment, the wireless transmitter station 110 is configured to transmit the bandlimited modulated signal over the wireless channel 130 to the wireless receiver station 120 in the form of a physical protocol data unit, PPDU.

As will be described in more detail in the following, according to embodiments disclosed herein the number of data tones

$${N}_{SD}^{IM}$$

(and, thus, the number of IM pilot tones

$${N}_{SP}^{IM} )$$

may be chosen by the wireless transmitter station 110 to be any arbitrary number smaller than the total number of tones of the RU or MRU or to be one or more specific values, such as the size of a smaller RU or MRU defined by the IEEE 802.11 framework of standards. For embodiments, where the number of data tones

$${N}_{SD}^{IM}$$

(and, thus, the number of IM pilot tones

$${N}_{SP}^{IM} )$$

may be chosen by the wireless transmitter station 110 to be any arbitrary number smaller than the total number of the data tones of the RU or MRU, this value

$${N}_{SD}^{IM}$$

may be used by both transmitter and receiver to determine all LDPC related parameters, such as the number of LDPC codewords and the number of punctured bits, the number of data bits per symbol (N_{DBPS}) and the number of coded bits per symbol (N_{CBPS}). In other words, instead of using N_{SD} and the payload size to compute all the necessary parameters (as done by WLAN transmitters nowadays), transmitters and receivers will use

$${N}_{SD}^{IM}$$

and the payload size to compute all the necessary parameters.

According to an embodiment, within an RU or MRU of size K subcarriers, i.e. tones (which corresponds to N_{SD} data tones per OFDM symbol), the wireless transmitter station 110 is configured to allocate any number of data tones

$${N}_{SD}^{IM}$$

as the first subset of the plurality of tones of the RU or MRU, where

$${N}_{SD}^{IM} < {N}_{SD} .$$

The remaining tones (or at least a portion thereof), i.e.

$${N}_{SP}^{IM} = {N}_{SD} - {N}_{SD}^{IM} ,$$

are allocated as the IM pilots defining the second subset of the RU or MRU. As will be appreciated, prior to the tone mapping operation implemented by the wireless transmitter station 110, the

$${N}_{SD}^{IM}$$

data tones may, in principle, be located anywhere within the OFDM symbol. According to an embodiment, the

$${N}_{SD}^{IM}$$

data tones may be placed contiguously either as the first or the last

$${N}_{SD}^{IM}$$

tones of the total number of tones N_{SD} of the RU or MRU. Similarly, the

$${N}_{SP}^{IM}$$

IM pilots may be located anywhere, preferably consecutively at the beginning or the end of the frequency mapping.

After the data tone and IM pilot tone allocation, the wireless transmitter station 110 is configured to apply LDPC tone mapping to all N_{SD} tones. In other words, the LDPC tone mapper(s) 311 (illustrated in FIGS. 3a and 3c and implemented by the wireless transmitter station 110 according to an embodiment) is operated across both data and IM pilot tones (together), such that they are all spread in the RU or MRU tones boundary. In an embodiment, the number of CFO pilots as well as the frequency locations of these CFO pilots remains the same as defined in IEEE 802.11ax/be, i.e. K-N_{SD} tones may be used by the wireless transmitter station 110 as CFO pilots.

In an embodiment, the modulated signal comprises the data part of a physical protocol data unit, PPDU, wherein the data part of the PPDU comprises a sequence of OFDM or OFDMA symbols, wherein the number of data tones of the last symbol of the sequence of OFDM or OFDMA symbols is an integer multiple of the parameter N_{SD,short} (already described above) and smaller than the number of data tones of the other symbols of the sequence of OFDM or OFDMA symbols. In an embodiment, the value of N_{SD,short} may be determined by the wireless transmitter station 110 in one of the following ways.

According to a first embodiment, N_{SD,short} may be largest value of N_{SD,short} defined by the IEEE 802.11ax/be/bn specification, that is smaller than or equal to

$${N}_{SD}^{IM} ,$$

i.e. the number of data tones of the first subset. For instance, if, by way of example, N_{SD}=102 and

$${N}_{SD}^{IM} = 82 ,$$

then the value of N_{SD,short} chosen by the wireless transmitter station 110 may correspond to (in one exemplary case) a 52+26-tone RU which is smaller than the value of 82. For certain very small RU sizes, e.g. a 26-tone RU, fixed values (e.g. 2) may be set.

According to a further embodiment, new values not specified in IEEE 802.11ax/be/bn may be chosen for the parameter N_{SD,short} for computing the number of data tones of the last OFDM symbol based on the following equation:

$${N}_{SD , short} = round [ ( {N}_{SD}^{IM} / {N}_{SD} ) \cdot {N}_{SD , short}^{standart} ] ,$$

wherein round[ ] denotes a rounding-to-the-nearest-integer operation and

$${N}_{SD , short}^{standart}$$

is used to determine the number of data tones of the last symbol of the sequence of OFDM or OFDMA symbols defined by the IEEE 802.11 framework of standards for the RU or MRU, when the last OFDM or OFDMA symbol is not fully used by data symbols. For example, if for a 242-tone RU the values

$${N}_{SD}^{IM} = 150 and {N}_{SD , short}^{standard} = 60$$

are used, then the value of N_{SD,short} may be N_{SD,short}=round[(150/234)·60], e.g. 38 for a round-down operation or 39 for a round-up operation. As will be appreciated, these values of 38 and 39 are approximately ¼ of the value of

$${N}_{SD}^{IM} = 150.$$

According to a further embodiment, the value of the parameter N_{SD,short} for computing the number of data tones of the last OFDM symbol is given by:

$${N}_{SD , short} = round [ {N}_{SD}^{IM} / 4 ] ,$$

wherein round[ ] denotes a rounding-to-the-nearest-integer operation.

In an embodiment, the wireless transmitter station 110 is configured to transmit an indication to the wireless receiver station 120 indicating that the RU or MRU used for transmission to the wireless receiver station 120 includes the second subset of the plurality of tones of the RU or MRU. In an embodiment, the indication to the wireless receiver station 120 may be further indicative of, e.g. comprise a value of the number of tones

$${N}_{SD}^{IM}$$

of the first subset of the plurality of tones of the RU or MRU. In an embodiment, the indication may comprise one or more bits (e.g. 1 bit to indicate if it is used or not (for a fixed value per each RU size) and multiple bits to indicate the explicit size) of one or more PHY header fields of a PPDU, wherein the one or more PHY header fields comprise a Universal SIG, U-SIG, field, and/or an Ultra High Reliability SIG, UHR-SIG, field. As already described above, in an embodiment, the wireless transmitter station 110 may be implemented as an AP and configured to transmit a plurality of beacon frames to the wireless receiver station 120 in the form of a non-AP station 120, wherein one or more of the plurality of beacon frames comprise the indication.

As already described above, in an embodiment the wireless transmitter station 110 may comprise the segment parser(s) 308a illustrated in FIG. 3c and configured to divide (in case the RU or MRU is larger than 996-tones) the RU or MRU into a plurality of segments such that each segment of the plurality of segments comprises one or more tones of the second subset of the plurality of tones of the RU or MRU. In an embodiment, each segment parser 308a is configured to divide the RU or MRU into the plurality of segments such that for each segment of the plurality of segments the ratio between the number of tones of the first subset and the second subset is approximately equal. As will be appreciated, this implementation is similar to the segment parser implementation specified in IEEE 802.11be.

As already described above, according to further embodiments disclosed herein the number of data tones

$${N}_{SD}^{IM}$$

$$( and , thus , the number of IM pilot tones {N}_{SP}^{IM} )$$

may be chosen by the wireless transmitter station 110 to be one or more specific values, such as the size of a smaller RU or MRU defined by the IEEE 802.11 framework of standards. Thus, in an embodiment, the RU or MRU defined by the IEEE 802.11 framework of standards comprises 26, 52, 52+26, 106, 106+26, 242, 484, 484+242, 996, 996+484, 996+484+242, 2*996, 2*996+484, 3*996, 3*996+484 or 4*996 tones. As will be appreciated, the RU or MRU defined by the IEEE 802.11 framework of standards is different from the RU or MRU used for allocating the first subset. For instance, for a MRU106+26 the wireless transmitter station 110 is configured to allocate the first subset of the plurality of data tones of the MRU106+26 as data tones for carrying modulated data, in particular quadrature amplitude modulation, QAM, symbols, based on the bit sequence, wherein the number of tones of the first subset corresponds to the number of tones of, for instance, a RU106, i.e. a RU with 106 tones.

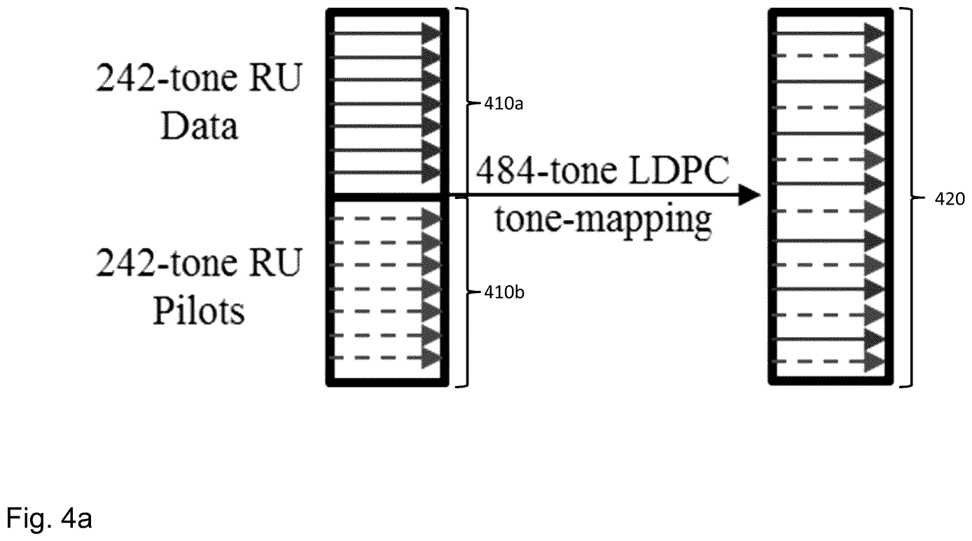

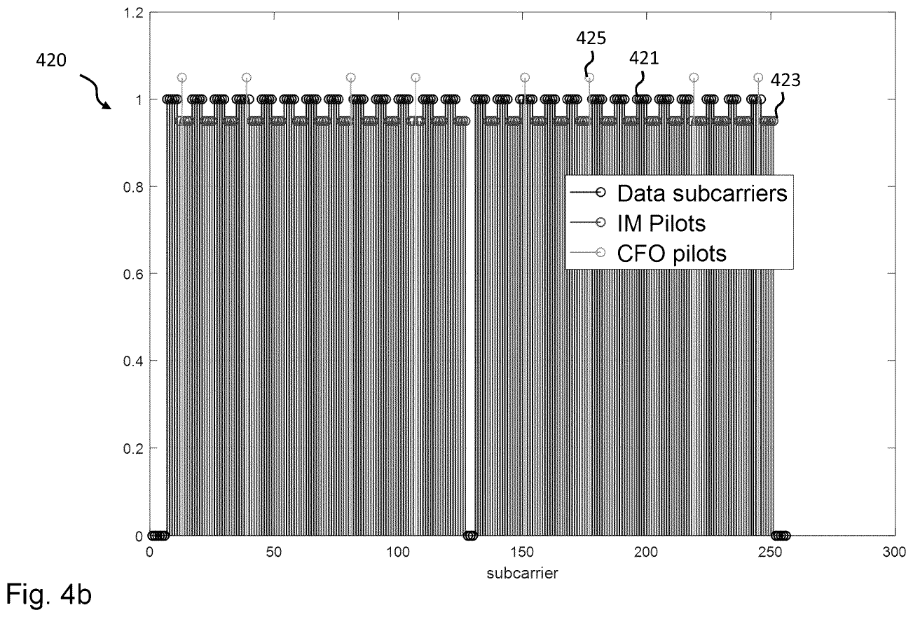

FIGS. 4a,b show diagrams illustrating the allocation of data tones and IM pilot tones in a RU or MRU 420 used by the wireless transmitter station 110 according to different embodiments. In the example shown schematically in FIG. 4a, the first allocated subset is a 242-tone RU 410a for data and the adjacent second allocated subset is a 242-tone RU 410b for IM pilots. A 484-tone LDPC tone mapping sequence is used by the wireless transmitter station 110 to spread both the data and the IM pilot symbols in frequency within the OFDM symbol subcarriers.

In an embodiment, the wireless transmitter station 110 is configured to first allocate the first subset of the plurality of data tones of the RU or MRU and then allocate the remaining data tones of the RU or MRU not being part of the first subset as the second subset of the plurality of data tones of the RU or MRU. Alternatively, the wireless transmitter station 110 is configured to first allocate the second subset of the plurality of data tones of the RU or MRU and then allocate the remaining data tones of the RU or MRU not being part of the second subset as the first subset of the plurality of data tones of the RU or MRU.

According to an embodiment, within an RU of size K, i.e. having K subcarriers or tones (which corresponds to N_{SD} data tones per OFDM symbol, where N_{SD}≤K), the wireless transmitter station 110 is configured to allocate a valid number of data tones (i.e. the first subset) corresponding to an already IEEE 802.11 standard compliant RU/MRU denoted

$${N}_{SD}^{IM} ,$$

wherein

$${N}_{SD}^{IM} < {N}_{SD} .$$

The remaining tones

$${N}_{SP}^{IM} = {N}_{SD} - {N}_{SD}^{IM}$$

are allocated for the IM pilots, i.e. the second subset. As will be appreciated, prior to tone mapping the

$${N}_{SD}^{IM}$$

data tones, i.e. the first subset of tones may in principle be placed anywhere within the OFDM symbol. According to an embodiment the

$${N}_{SD}^{IM}$$

data tones, i.e. the first subset of tones may be arranged contiguously either as the first or the last

$${N}_{SD}^{IM}$$

entries out of the N_{SD} tones. As already described above, the wireless transmitter station 110 is configured to apply LDPC tone mapping on all N_{SD} tones. In other words, the LDPC tone mapper is operated across both data and IM pilot tones (together), such that they are all spread in frequency.

According to an embodiment, the number of CFO pilots of the RU or MRU is unchanged with respect to 802.11ax/be, which means that K-N_{SD} tones (where N_{SD}<K) are used for CFO pilots, and their location in frequency is unchanged relative to the existing standard specification.

FIG. 4b shows an example for a 242-tone RU (i.e. K=242) 420 generated by the wireless transmitter station 110 according to an embodiment, where

$${N}_{SD}^{IM} = 126$$

data tones (corresponding to a Multi-RU of size 106+26) and

$${N}_{SP}^{IM} = {N}_{SD} - {N}_{SD}^{IM} = 234 - 126 = 108$$

IM pilot tones undergo LDPC tone mapping corresponding to the 242-tone RU 420 (tone mapping sequence if of length 234). In an embodiment, the ultra-high reliability, UHR, short training field, STF, and long training field, LTF, may occupy the same subcarriers as that of the union of data and IM pilot subcarriers. FIG. 4b depicts the resulting assignment of all 256 input bins of the IDFT block 315 illustrated in FIGS. 3a and 3b, including CFO pilots and (null) guard subcarriers at the channel BW edges and centre, on top of the data and IM pilot subcarriers. As will be appreciated, in FIG. 4b the data tones (such as the exemplary data tone 421) of the RU 420 have, by way of example, a value of 1, while the IM pilot tones (such as the exemplary IM pilot tone 423) have a value slightly smaller than 1 and the CFO pilot tones (such as the exemplary CFO pilot tone 425) have a value slightly larger than 1.

According to a further embodiment the IM pilot tones may be allocated by the wireless transmitter station 110 at predefined indices, i.e. being associated with specific tones which after tone mapping will eventually be mapped onto predefined subcarrier frequencies. More specifically, for an RU of size K (which corresponds to N_{SD} data tones per OFDM symbol, wherein both K and N_{SD} comply with an already supported RU/MRU in the IEEE 802.11 standard), the wireless transmitter station 110 according to an embodiment may define in advance

$${N}_{SP}^{IM} = {N}_{SD} - {N}_{SD}^{IM}$$

indices for the IM pilot tones, i.e. the second tone subset, wherein

$${N}_{SP}^{IM} < {N}_{SD} .$$

The following are examples for predefined indices:
For K=242 and

$${N}_{SD}^{IM} = 102 + 24 = 1 \; 26 , {N}_{SP}^{IM} = 234 - 126 = 108$$

(and there are further 8 tones assigned for CFO pilots within the 242-tone RU under consideration). In this case, the 108 IM pilot indices may be spread by the wireless transmitter station 110 in contiguous groups in frequency, and since 108/234 ≈4/9 the indices may be defined, for instance, by the MATLAB instruction sort ([1:9:234, 2:9:234, 3:9:234, 4:9:234 231:234])=[1, 2, 3, 4, 10, 11, 12, 13, 19, 29, . . . , 226, 227, 228, 229, 231, 232, 233, 234], where the resulting 108 IM pilot indices listed on the right-hand side of the equation above form a subset of the 234 valid data subcarrier indices for a 242-tone RU.
For K=242 and

$${N}_{SD}^{IM} = 102 + 24 = 126 , {N}_{SP}^{IM} = 234 - 126 = 108.$$

In this case, the 108 IM pilot indices may be spread by the wireless transmitter station 110 (almost) evenly in frequency, defined, for instance, by the MATLAB instruction 1+floor (233/107*(0:107))=[1, 3, 5, 7, 9, 11, 14, 16, 18, . . . , 220, 223, 225, 227, 229, 231, 234], where the resulting 108 IM pilot indices listed on the right-hand side of the equation above form a subset of the 234 valid data tone indices for a 242-tone RU.

As already described above, the wireless transmitter station 110 may apply LDPC tone mapping onto all

$${N}_{SD} = {N}_{SD}^{IM} + {N}_{SP}^{IM}$$

tones (those assigned for data transmission out of the K tones of the RU, according to the IEEE 802.11 standard) for mapping to the corresponding frequency subcarrier indices. In an embodiment, the number of CFO pilots may be unchanged with respect to the IEEE 802.11ax/be standard, which means K-N_{SD} tones are used for CFO pilots, and their location in frequency is unchanged. In an embodiment, the ultra-high reliability, UHR, short training field, STF, and long training field, LTF, may occupy the same subcarriers as that of the union of data and IM pilot subcarriers.

As already illustrated in FIG. 4a and described above, in an embodiment the wireless transmitter station 110 may allocate the data and the IM pilots in separate valid RUs 410a,b. More specifically, in an embodiment, the wireless transmitter station 110 may allocate the data to an RU #1 of size K₁ subcarriers (which corresponds to N_{SD,1} data tones per OFDM symbol, wherein N_{SD,1}≤K₁), and the IM pilots to an RU #2 of size K₂ subcarriers (which corresponds to N_{SD,2} data tones per OFDM symbol, wherein N_{SD,1}≤K₁). The two RUs are contained within a larger RU of size K (where K≥K₁+K₂, and the RU of size K corresponds to N_{SD} data tones, wherein N_{SD}≤K). In an embodiment, N_{SD}, N_{SD,1} and N_{SD,2} comply with the numbers of data tones of some RU sizes K, K₁ and K₂, respectively, which are specified in the IEEE 802.11 standard.

The QAMs corresponding to RU #1 and RU #2 are mapped in frequency to their respective subcarrier indices within the larger RU (of size K). LDPC tone mapping is then applied by the wireless transmitter station 110 to all N_{SD} tones, i.e. subcarriers, which means all data and IM pilots are mixed and spread in frequency. In an embodiment, the number of CFO pilots is unchanged, which means K-N_{SD} tones are used for CFO pilots, and their location in frequency is unchanged (corresponding to the larger RU of size K). As will be appreciated, however, unlike in some of the previous embodiments, for this embodiment there may be leftover (unused) tones, and their number is N_{SD}−(N_{SD,1}+N_{SD,2}).

According to a further embodiment the wireless transmitter station 110 is configured to allocate the plurality of IM pilot tones, i.e. the second tone subset, using a distributed RU. Instead of transmitting resource units which are contiguous and localized in frequency, there have been suggestions to distribute the tones of an RU over a wider BW so as to increase the separation, in frequency, between two adjacent data tones allocated to the same receiving station 120. The main motivation for this suggestion has been to allow for higher transmit power which is sometimes limited due to the PSD limitation imposed by regulation bodies.

One simple example for a distributed RU is a 26-tone RU which is spread over a bandwidth of 20 MHz, which may mean separating each two adjacent tones of the 26-tone RU by 9 tones (considering the tone plan of IEEE 802.11ax and IEEE 802.11be, there are nine 26-tone RUs within 20 MHz). In this manner multiple distributed RUs can be located within a certain BW, each occupying interlaced disjoint sets of frequency subcarriers.

In an exemplary embodiment, the wireless transmitter station 110 may be configured to use a single distributed RU for IM pilots, and all other distributed RUs are used for data. For example, in 20 MHz three 52-tone RUs may be allocated for data and a single 52-tone RU for IM pilots, the frequency subcarriers of each 52-tone RU distributed (with at least 4-subcarrier separation) within the 20 MHz bandwidth after frequency mapping operation (313).

According to the standard IEEE 802.11be, when the MRU size is larger than 996 tones (corresponding to an 80 MHz frequency subblock), there is a segment parser operation which defines how bits are spread between the components within each 80 MHz frequency subblock. In addition, when the components in the frequency subblocks are not all of the same size, the segment parser defines how the left-over bits are handled. Furthermore, when the RU size is larger than 996-tones, LDPC tone mapping operates on each 80 MHz frequency subblock (996-tones or smaller) separately. In an embodiment, the wireless transmitter station 110 is configured to handle cases involving an RU/MRU of size larger than 996 by splitting such an RU/MRU into multiple RUs or MRUs, each of size 996 or smaller.

In the following different embodiments for the IM pilot content, i.e. payload or signal values of the IM pilot tones, are described. In an embodiment, the IM pilot tones may carry sequences of IM pilot values, where the sequences are chosen so that they lead to a low PAPR of the IM pilot sequence (similar to the motivation used for setting the CFO pilot sequence in IEEE 802.11n), and all sequences (corresponding to different BW values and different RU sizes) can be generated from a single (or few) short sequences, such that memory storage requirements are reduced. In an embodiment, the wireless transmitter station 110 may be configured to use one or more of the following generator BPSK symbol sequences M1, M2, M3, M4, with M1=[−1 1 −1 −1 −1 −1], M2=[1 −1 −1 −1 1 −1], M3=[1 1 1 −1 −1 −1], and M4=[M1 M2 M3]=[−1 1 −1 −1 −1 −1 1 −1 −1 −1 1 1 1 −1 −1 −1].

In an embodiment, the wireless transmitter station 110 may be configured to generate longer sequences from the generator sequences M1, M2, M3, M4 by concatenating and multiplying these generator sequences by certain overall phase factors, in particular certain sign factors±1. For instance, in an embodiment, for data MRUs of sizes 106+26 or 52+26 or a data RU of size 52, where 24 IM pilots are used, the wireless transmitter station 110 may concatenate copies of the generator sequences M1, M2 and M3 as [M1, M2, M3, M3] to form a length 24 BPSK symbol sequence [−1 1 −1−1 −1−1 1 −1−1 −1 1 −1 1 1 1 −1−1 −1 1 1 −1 −1 −1] which is then used as the values assigned for the 24 IM pilot tones. In other embodiments, the following examples of concatenation and multiplication procedures of the generator BPSK symbol sequences M1, M2, M3, M4 are employed for generating IM pilot sequences to be used by the wireless transmitter station 110 when configured to operate with RUs or MRUs of the following respective sizes:
in case of a data RU of size 106 which contains 30 IM pilots, the generator sequences may be concatenated as [M2, M3, M1, M2, M2] to form an IM pilot symbol sequence [1 −1 −1−1 1 −1 1 1 1 −1−1 −1−1 1 −1−1 −1−1 1 −1−1 −1 1 −1 1 −1 −1 −1 1 −1] of length 30;
in case of a data RU of size of 106 which contains 54 IM pilots, the generator sequences may be concatenated as [M3, M2, M1, M2, M2, M2, M3, M2, M3] to form an IM pilot symbol sequence of length 54;

in case of a data RU of size 242 which contains 108 IM pilots, six replicas of the generator sequence M4 may be concatenated, where each replica is multiplied by a respective overall sign factor in the sequence [−1 1 −1−1 −1 1] to form an IM pilot symbol sequence of length 108;
in case of a data RU of size 484 or an MRU of size 484+242 containing 234 IM pilots, thirteen replicas of the generator sequence M4 may be concatenated, where each replica is multiplied by a respective overall sign factor in the sequence [−1 1 1 1 1 −1 1 1 −1 1 1 1 −1] to form an IM pilot symbol sequence of length 234;
in case of a data RU of size 996 which contains 278 IM pilots, fifteen replicas of the generator sequence M4 may be concatenated, where each replica is multiplied by a respective overall sign factor in the sequence [1 1 1 1 1 −1 1 −1 1 −1−1 1 1 −1−1]. The resulting symbol sequence of length 270 may be further appended by the 8-symbol sequence [1, M1, −1] to form an IM pilot symbol sequence of length 278;
in case of a data RU of size 996 which contains 512 IM pilots, twenty-eight replicas of the generator sequence M4 may be concatenated, where each replica is multiplied by a respective overall sign factor in the sequence [−1 1 1 −1 1 −1 1 1 1 1 −1 1 −1 1 1 −1 −1 1 −1 −1 −1 1 1 1 −1 1 1 1]. The resulting symbol sequence of length 504 may be further appended by the 8-symbol sequence [1, M1, −1] to form an IM pilot symbol sequence of length 512;

in case of a data RU or MRU of size larger than 996, the data RU or MRU is defined according to the IEEE 802.11 framework of standards as an aggregation of component RUs or MRUs of sizes which are all smaller or equal to 996; accordingly, the IM pilot content of the data RU or MRU may be defined in terms of the content of the aggregated IM pilots of the respective component RUs or MRUs, for instance following the procedure described above.

According to a further embodiment, the wireless transmitter station 110 may be configured to transmit a zero value, i.e. a null signal on at least some of the allocated IM pilot tones, As will be appreciated, this allows increasing the power of the allocated data tones correspondingly (for example, if half the tones are allocated for IM pilots, then if IM pilots are transmitted with zero energy, the data power of the data tones can be doubled, i.e. increased by 3 dB), while keeping the total power allocated for transmission over the RU under consideration unchanged.

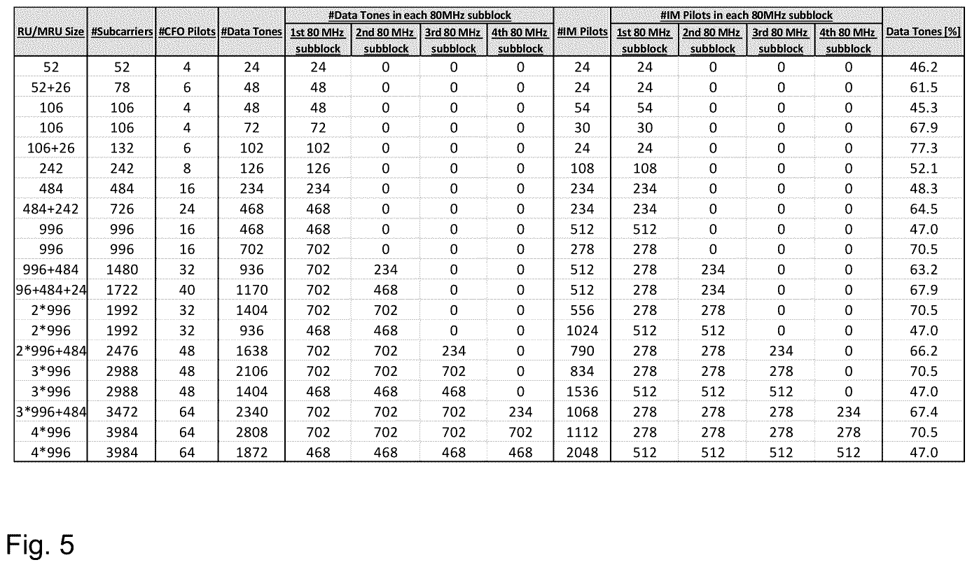

In the following, several embodiments will be described concerning the signalling of the allocation used by the wireless transmitter station 110 to the wireless receiver station(s) 120. The table shown in FIG. 5 lists the various values of sizes of an RU or MRU, for which—beyond CFO pilot tones-a portion of the tones is used for data and the rest of the tones are used for IM pilots. Columns 5-8 in the table list for each RU or MRU the number of data tones allocated in each 80 MHz frequency subblock (i.e. in the first subblock, and in the other subblocks if applicable, namely when #Subcarriers is greater than 996). Furthermore, columns 10-13 list the number of IM Pilots allocated in each 80 MHz frequency subblock, for each RU or MRU. The right-most column shows the percentage of subcarriers allocated for data tones out of the whole RU/MRU size. For example, for an MRU of size 2*996+484, which is transmitted within three subblocks, the respective number of data tones in these three subblocks is 702, 702 and 234, whereas the number of IM pilots is 278, 278 and 234, respectively. As will be appreciated, there are instances where the same RU/MRU size can be used with different choices for the number of data tones.

Based on, for instance, the table shown in FIG. 5, the wireless transmitter station 110 may be configured to implement the following signalling options. According to a first embodiment, the wireless transmitter station 110 may use a single bit, i.e. flag bit, for indicating a transmission to be an ultra-reliable transmission, i.e. to include the allocation of data tones and IM pilot tones described above. In case of a non-OFDMA transmission this single bit may be part of the U-SIG/overflow of the UHR-SIG. In case of an OFDMA transmission this single bit may be part of the UHR-SIG. For each RU size listed in the table of FIG. 5, only a single row is supported (one of the two, in the 4 cases where two rows with same RU size are listed). For every allocation RU size indicated in the U-SIG/UHR-SIG/Trigger Frame, the number of IM pilots and their location is always known to both transmitter and receiver sides.

According to a further embodiment, the wireless transmitter station 110 may use at least two bits for indicating a transmission to be an ultra-reliable transmission, i.e. to include the allocation of data tones and IM pilot tones described above. The at least two bits (for instance, in U-SIG/UHR-SIG/Trigger Frame) may indicate the transmission to include the allocation of data tones and IM pilot tones described above as well as which portion of the RU is allocated for IM pilots. Here more than a single value of number of data tone may be supported as alternative employed modes of operation for a specific RU size.

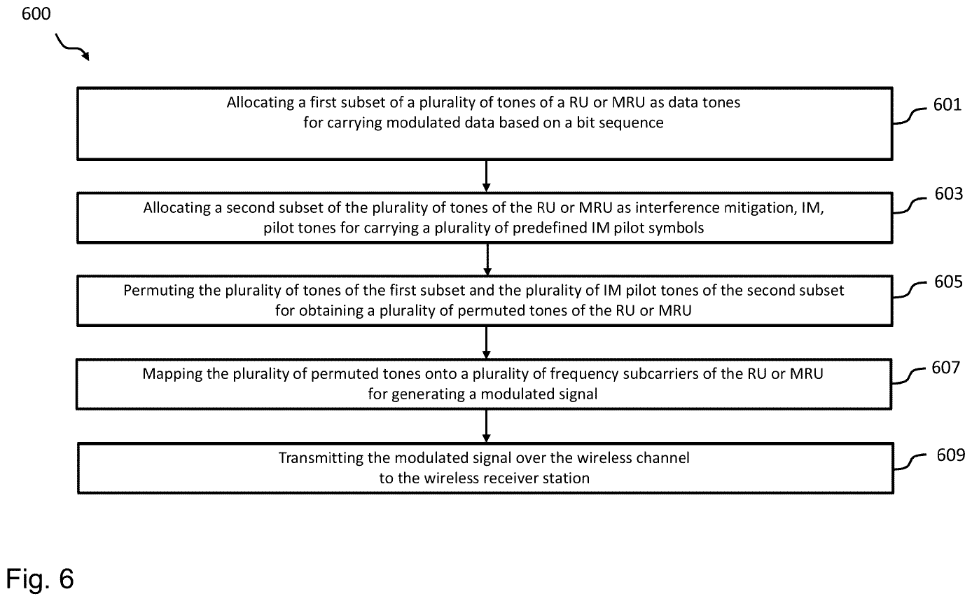

FIG. 6 shows a flow diagram illustrating steps of a method 600 of operating the wireless transmitter station 110 for transmitting a bit sequence to the wireless receiver station(s) 120 over the wireless channel 130 using a RU or MRU of a OFDM or OFDMA communication scheme. The method 600 comprises a step 601 of allocating a first subset of a plurality of tones of the RU or MRU as data tones for carrying modulated data based on the bit sequence. The method 600 comprises a further step 603 of allocating a second subset of the plurality of tones of the RU or MRU as interference mitigation, IM, pilot tones for carrying a plurality of predefined IM pilot symbols. Moreover, the method 600 comprises a step 605 of permuting the plurality of tones of the RU or MRU, including both the first subset comprising

$${N}_{SD}^{IM}$$

data tones and the second subset comprising

$${N}_{SP}^{IM}$$

IM pilot tones, for obtaining a plurality of permuted tones of the RU or MRU. The method 600 further comprises a step 607 of mapping the plurality of permuted tones onto a plurality of frequency subcarriers of the RU or MRU for generating a modulated signal and a step 609 of transmitting the modulated signal over the wireless channel 130 to the wireless receiver station 120.

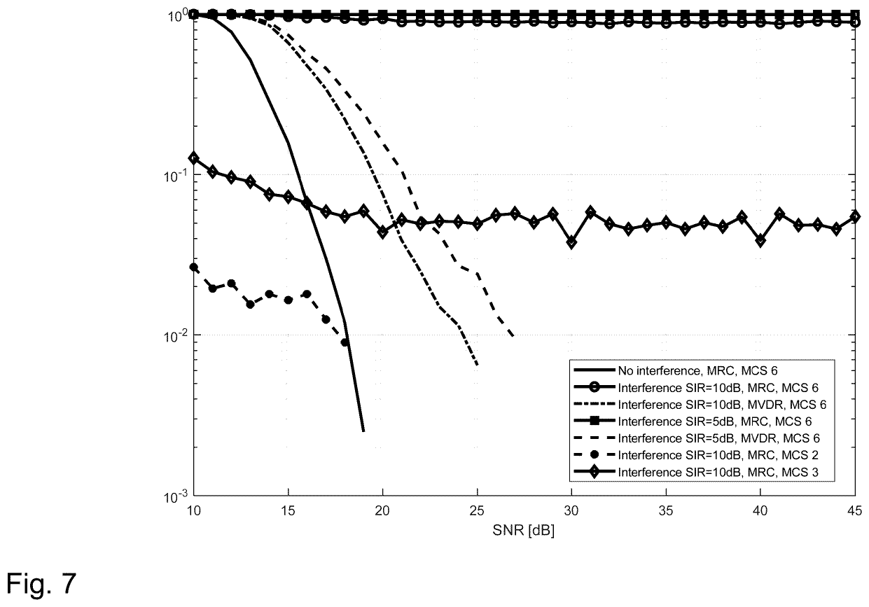

FIG. 7 shows graphs illustrating the link performance (PER vs. SNR at the receiver) of employing different TX-RX schemes by the wireless transmitter station 110 and wireless receiver station 120, according to different embodiments. The results shown in FIG. 7a are based on a link-level simulation with the following setup: 106-tone RU with MCS 6 (64QAM rate ¾); Interference on the entire RU, SIR=10 dB and SIR=5 dB; 1 Tx antenna, 4 Rx antennas, 1 spatial stream, practical channel estimation. The results shown in FIG. 7 illustrate: (a) the significant impact on performance of the deployment of MVDR-based interference mitigation by the receiver, relying on interference estimation based on the IM pilots inserted by the transmitter into the transmitted signal according to an embodiment; (b) an error floor when plain MRC is used by the receiver, namely when the detection algorithm ignores the presence of the interference, and (c) the performance of plain MRC while the transmitter chooses to transmit the data using lower MCS values, namely 2 or 3. As can be taken from FIG. 7, the Rx interference mitigation (made possible by embodiments of the wireless transmitter station 110 disclosed herein) leads to a significant performance improvement and a highly reliable transmission even in the presence of a strong interference. Using a significantly lower MCS (e.g. MCS 3, i.e. 16QAM rate ½, meaning spectral efficiency of 2 bps/Hz, which is lower than half the spectral efficiency of MCS 6, i.e. 64QAM rate ¾, meaning spectral efficiency of 4.5 bps/Hz) still leads to undesirable error floors.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units are integrated into one unit.

1. A wireless transmitter station for transmitting a bit sequence to a wireless receiver station over a wireless channel using a resource unit (RU) or multiple resource unit (MRU) of an Orthogonal Frequency Division Multiplexing (OFDM) or Orthogonal Frequency Division Multiple Access (OFDMA) communication, the wireless transmitter station comprising:
processing circuitry configured to:
allocate a first subset of a plurality of tones of the RU or MRU as data tones for carrying modulated data based on the bit sequence, the first subset comprising
$${N}_{S D}^{IM}$$
data tones;
allocate a second subset of the plurality of tones of the RU or MRU as interference mitigation (IM) pilot tones for carrying a plurality of predefined IM pilot symbols, the second subset comprising
$${N}_{SP}^{IM}$$
IM pilot tones;
permute the plurality of tones of the RU or MRU, including both the first subset and the second subset, for obtaining a plurality of permuted tones of the RU or MRU;
map the plurality of permuted tones onto a plurality of frequency subcarriers of the RU or MRU for generating a modulated signal; and
a transmitter configured to:
transmit the modulated signal over the wireless channel to the wireless receiver station.

2. The wireless transmitter station of claim 1, wherein the modulated signal comprises the data part of a physical protocol data unit (PPDU), and wherein the data part of the PPDU comprises a sequence of OFDM or OFDMA symbols, wherein the number of data tones of the last symbol of the sequence of OFDM or OFDMA symbols is an integer multiple of a parameter N_{SD,short} and smaller than the number of data tones of the other symbols of the sequence of OFDM or OFDMA symbols.

3. The wireless transmitter station of claim 2, wherein the value of the parameter N_{SD,short} for computing the number of data tones of the last OFDM symbol is equal to the value of N_{SD,short} that corresponds to the largest RU or MRU
$${N}_{SD , short}^{standard}$$
as defined by the IEEE 802.11 framework of standards that is smaller than the number of data tones of the first subset.

4. The wireless transmitter station of claim 2, wherein the value of the parameter N_{SD,short} for computing the number of data tones of the last OFDM symbol is given by:
$${N}_{SD , short} = round [ ( {N}_{SD}^{IM} / {N}_{SD} ) \cdot {N}_{SD , short}^{standard} ] ,$$
wherein round[ ] denotes a rounding-to-the-nearest-integer operation and
$${N}_{SD , short}^{standard}$$
is used to determine the number of data tones of the last symbol of the sequence of OFDM or OFDMA symbols defined by the IEEE 802.11 framework of standards for the RU or MRU, when the last OFDM or OFDMA symbol is not fully used by data symbols.

5. The wireless transmitter station of claim 2, wherein the value of the parameter N_{SD,short} for computing the number of data tones of the last OFDM symbol is given by:
$${N}_{SD , short} = round [ {N}_{SD}^{IM} / 4 ] ,$$
wherein round[ ] denotes a rounding-to-the-nearest-integer operation.

6. The wireless transmitter station of claim 1, wherein the transmitter is configured to transmit an indication to the wireless receiver station indicating that the RU or MRU includes the second subset of the plurality of tones of the RU or MRU.

7. The wireless transmitter station of claim 6, wherein the indication to the wireless receiver station is further indicative of the number of tones
$${N}_{SD}^{IM}$$
of the first subset.

8. The wireless transmitter station of claim 6, wherein the transmitter is configured to transmit the modulated signal over the wireless channel to the wireless receiver station in the form of a physical protocol data unit (PPDU),
wherein the indication comprises one or more bits of one or more PHY header fields of the PPDU, and
wherein the one or more PHY header fields comprise at least one of a Universal SIG (U-SIG) field and an Ultra High Reliability SIG (UHR-SIG) field.

9. The wireless transmitter station of claim 6, wherein the transmitter is configured to transmit a plurality of beacon frames to the wireless receiver station, and
wherein one or more of the plurality of beacon frames comprise the indication.

10. The wireless transmitter station of claim 1, the wireless transmitter station further comprising a segment parser configured to divide the RU or MRU into a plurality of segments such that each segment of the plurality of segments comprises one or more tones of the second subset of the plurality of tones of the RU or MRU.

11. The wireless transmitter station of claim 10, wherein the segment parser is configured to divide the RU or MRU into the plurality of segments such that, for each segment of the plurality of segments, the ratio between the number of tones of the first subset and the second subset is approximately equal.

12. The wireless transmitter station of claim 1, wherein the first subset of the plurality of tones of the RU or MRU comprises a number of tones corresponding to the tones of a RU or MRU defined by the IEEE 802.11 framework of standards.

13. The wireless transmitter station of claim 12, wherein the processing circuitry is configured to first allocate the first subset of the plurality of tones of the RU or MRU and then allocate remaining tones of the RU or MRU not being part of the first subset as the second subset of the plurality of tones of the RU or MRU.

14. The wireless transmitter station of claim 12, wherein the processing circuitry is configured to first allocate the second subset of the plurality of tones of the RU or MRU and then allocate the remaining tones of the RU or MRU not being part of the second subset as the first subset of the plurality of tones of the RU or MRU.

15. The wireless transmitter station of claim 12, wherein the processing circuitry is configured to allocate the second subset as a plurality of subgroups of tones spread over one or more frequency ranges defined by the plurality of tones of the RU or MRU, wherein each subgroup of tones comprises a plurality of contiguous tones.

16. The wireless transmitter station of claim 12, wherein the RU or MRU defined by the IEEE 802.11 framework of standards comprises 26, 52, 52+26, 106, 106+26, 242, 484, 484+242, 996, 996+484, 996+484+242, 2*996, 2*996+484, 3*996, 3*996+484 or 4*996 tones.

17. The wireless transmitter station of claim 12, wherein the RU or MRU further comprises a plurality of carrier frequency offset (CFO) pilot tones.

18. The wireless transmitter station of claim 12, wherein the processing circuitry is configured to perform the permutation operation using a LDPC tone-mapper as specified by the IEEE 802.11 framework of standards.

19. The wireless transmitter station of claim 12, wherein the processing circuitry is configured to generate the IM pilot tone symbols for one or more of the plurality of IM pilot tones by combining or concatenating one or more generator binary phase-shift keying (BPSK) symbol sequences one or more times and by multiplying each generator BPSK symbol sequence by a factor of 1 or −1.

20. The wireless transmitter station of claim 19, wherein for combining or concatenating the one of more generator BPSK symbol sequences, the processing circuitry is configured to insert up to 5 additional BPSK symbols between the one or more generator BPSK symbol sequences.

21. The wireless transmitter station of claim 19, wherein the one or more generator BPSK symbol sequences comprises one or more of the following BPSK symbol sequences: [−1 1 −1 −1 −1 −1]; [1 −1 −1 −1 1 −1]; [1 1 1 −1 −1 −1]; or [−1 1 −1 −1 −1 −1 1 −1 −1 −1 1 −1 1 1 1 −1 −1 −1].

22. The wireless transmitter station of claim 12, wherein the transmitter is configured to transmit a null signal over one or more of the plurality of IM pilot tones.

23. A method for transmitting a bit sequence to a wireless receiver station over a wireless channel using a resource unit (RU) or multiple resource unit, (MRU) of an Orthogonal Frequency Division Multiplexing (OFDM) or Orthogonal Frequency Division Multiple Access (OFDMA) communication, the method comprising:
allocating a first subset of a plurality of tones of the RU or MRU as data tones for carrying modulated data based on the bit sequence, the first subset comprising
$${N}_{S D}^{IM}$$
data tones;
allocating a second subset of the plurality of tones of the RU or MRU as interference mitigation (IM) pilot tones for carrying a plurality of predefined IM pilot symbols, the second subset comprising
$${N}_{SP}^{IM}$$
IM pilot tones;
permuting the plurality of tones of the RU or MRU for obtaining a plurality of permuted tones;
mapping the plurality of permuted tones onto a plurality of frequency subcarriers of the RU or MRU for generating a modulated signal; and
transmitting the modulated signal over the wireless channel to the wireless receiver station.

24. A non-transitory computer-readable medium storing instructions that, when executed by one or more processors of a wireless transmitter station, cause the wireless transmitter station to perform a method for transmitting a bit sequence to a wireless receiver station over a wireless channel using a resource unit (RU) or multiple resource unit (MRU) of an Orthogonal Frequency Division Multiplexing (OFDM) or Orthogonal Frequency Division Multiple Access (OFDMA) communication system, the method comprising:
allocating, by the one or more processors, a first subset of a plurality of tones of the RU or MRU as data tones for carrying modulated data based on the bit sequence, the first subset comprising
$${N}_{SD}^{IM}$$
data tones;
allocating, by the one or more processors, a second subset of the plurality of tones of the RU or MRU as interference-mitigation (IM) pilot tones for carrying a plurality of predefined IM pilot symbols, the second subset comprising
$${N}_{SP}^{IM}$$
IM pilot tones;
permuting, by the one or more processors, the plurality of tones of the RU or MRU for obtaining a plurality of permuted tones;
mapping, by the one or more processors, the plurality of permuted tones onto a plurality of frequency subcarriers of the RU or MRU to generate a modulated signal; and
causing transmission of the modulated signal over the wireless channel to the wireless receiver station.
